(19) United States
(12) Patent Application Publication
(10) Pub. No.: US 2011/0018970 A1
(43) Pub. Date: Jan. 27, 2011

(54) COMPOUND-EYE IMAGING APPARATUS

(75) Inventor: Satoru WAKABAYASHI, Kurokawa-gun (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM CORPORATION, Tokyo (JP)

(21) Appl. No.: 12/837,361

(22) Filed: Jul. 15, 2010

(30) Foreign Application Priority Data
Jul. 21, 2009 (JP) JP2009-170248
Mar. 9, 2010 (JP) JP2010-051842

(51) Int. Cl. H04N 13/02

(52) U.S. Cl. 348/47; 348/E13.074

(57) ABSTRACT

An object is to provide a compound-eye imaging apparatus in which a plurality of plane images in different image taking ranges can be taken by a plurality of image pickup devices, and also, a user can recognize the image taking ranges of the plurality of plane images and confirm details of a subject. When a simultaneous tele/wide image taking mode is set, zoom positions of a zoom lens of a right imaging system and a zoom lens of a left imaging system are set to be different from each other, and a wide-side image can be taken by the right imaging system, and a tele-side image can be taken by the left imaging system. Based on the positions of the zoom lens and the zoom lens, guidance, which is a figure in which a frame indicating the image taking range of a wide-image and a frame indicating the image taking range of a tele-image are superimposed so that centers of the frame and the frame coincide with each other, is generated, and a live view image taken by the right imaging system and the guidance are displayed in a superimposed manner. The guidance is displayed so as to be superimposed on a tele-side live view image.

### BACKGROUND OF THE INVENTION

1. Field of the Invention

The present invention relates to a compound-eye imaging apparatus, and more particularly, to a compound-eye imaging apparatus which can take a plurality of plane images in different image taking ranges.

2. Description of the Related Art

Japanese Patent Application Laid-Open No. 5-148090 proposes, in a camera in which optical zoom of up to 3× is enabled, a video camera in which, if an instruction for the zoom of 3× or more has been inputted, an image taken with the 3× optical zoom is displayed on a display unit, and a range to be enlarged by electronic zoom is surrounded by a frame.

Japanese Patent Application Laid-Open No. 2004-207774 proposes a digital camera in which subject images are formed on two imaging elements of different sizes, an image taken by a larger imaging element (wide-imaging element) is displayed on a display unit, and also, a range to be taken by a smaller imaging element (tele-imaging element) is surrounded by a frame and displayed, or the image taken by the wide-imaging element is displayed on the entire display unit and an image taken by the tele-imaging element is displayed in a small size at a corner of the display unit (first mode).

Moreover, Japanese Patent Application Laid-Open No. 2004-207774 proposes a digital camera which includes two display units of different sizes, and displays the images taken by the wide-imaging element and the tele-imaging element on the two display units, respectively (second mode).

In the invention described in Japanese Patent Application Laid-Open No. 5-148090, a zoom image taking range is displayed with the frame, and thus, a user can recognize the zoom image taking range. However, since the image which is actually displayed on the display unit is the image before being enlarged, there is a problem in that the user cannot confirm details of the image. Moreover, in the invention described in Japanese Patent Application Laid-Open No. 5-148090, only one imaging element is provided, and thus, there is a problem in that only the enlarged image can be recorded.

In the first mode of the invention described in Japanese Patent Application Laid-Open No. 2004-207774, the image taken by the wide-imaging element is mainly displayed on the display unit, and thus, similarly to the invention described in Japanese Patent Application Laid-Open No. 5-148090, there is the problem in that the user cannot confirm the details of the image. Moreover, in the second mode of the invention described in Japanese Patent Application Laid-Open No. 2004-207774, there is a problem in that the two display units are required for displaying two images. It should be noted that, since an imaging device described in Japanese Patent Application Laid-Open No. 2004-207774 includes the two imaging elements, two images can be taken and recorded, while there is no idea of recording both the two images.

### SUMMARY OF THE INVENTION

The present invention has been made in view of the above situation, and an object of the present invention is to provide a compound-eye imaging apparatus in which a plurality of plane images in different image taking ranges can be taken by a plurality of image pickup devices, and also, a user can recognize the image taking ranges of the plurality of plane images and confirm details of a subject.

In order to achieve the object, a compound-eye imaging apparatus according to a first aspect of the present invention which includes a plurality of image pickup devices, each of which includes an image taking optical system including a zoom lens and includes an imaging element on which a subject image is formed by the image taking optical system, the compound-eye imaging apparatus being capable of taking subject images viewed from a plurality of viewpoints, as a stereoscopic image, includes an image taking mode setting device which sets a multi-image taking mode in which a plane image is taken in a different image taking range for each image pickup device of the plurality of image pickup devices; a lens moving device which, if the multi-image taking mode is set, moves the zoom lens in an optical axis direction so that zoom positions of the plurality of image pickup devices are set to be different for each image pickup device; a control device which, if the zoom lens has been moved by the lens moving device, takes a plurality of the plane images in the different image taking ranges via the plurality of image pickup devices; a display device which can display the plane image or the stereoscopic image; and a display control device which, if the multi-image taking mode has been set, displays an image in a narrowest image taking range, in the plurality of plane images, on a full screen of the display device, and also displays guidance which includes frames indicating the image taking ranges of the plurality of plane images, and which indicates a relationship among the image taking ranges of the plurality of plane images, on the display device.

According to the compound-eye imaging apparatus according to the first aspect, if an image taking mode of the compound-eye imaging apparatus which can take the subject images viewed from the plurality of viewpoints, as the stereoscopic image, is set to the multi-image taking mode in which the plurality of plane images in the different image taking ranges are taken, the zoom lens is moved in the optical axis direction so that the zoom positions of the plurality of image pickup devices are set to be different for each image pickup device, and the plurality of plane images in the different image taking ranges are taken. Thereby, the plurality of plane images in the different image taking ranges can be taken.

Moreover, according to the compound-eye imaging apparatus according to the first aspect, the image in the narrowest image taking range, in the plurality of plane images which have been taken, is displayed on the full screen of the display device, and the guidance which includes the frames indicating the image taking ranges of the plurality of plane images, and which indicates the relationship among the image taking ranges of the plurality of plane images, is also displayed on the display device. Thereby, the user can recognize the image taking ranges of the plurality of plane images, and can also confirm the details of the subject.

In the compound-eye imaging apparatus according to a second aspect of the present invention, in the compound-eye imaging apparatus according to the first aspect, the display control device displays a figure in which a plurality of the frames indicating the image taking ranges of the plurality of plane images are superimposed so that centers of the frames coincide with each other, as the guidance.

According to the compound-eye imaging apparatus according to the second aspect, the image in the narrowest image taking range, in the plurality of plane images which have been taken, is displayed on the full screen of the display device, and the figure in which the plurality of frames indicating the image taking ranges of the plurality of plane images are superimposed so that the centers of the frames coincide with each other, is also displayed as the guidance on the display device. Thereby, the user can recognize the image taking ranges of the plurality of plane images at a glance.

In the compound-eye imaging apparatus according to a third aspect of the present invention, in the compound-eye imaging apparatus according to the second aspect, the display control device displays an image in a widest image taking range, in the plurality of plane images, so as to be superimposed within a frame indicating the image taking range of the image in the widest image taking range, in the plurality of plane images.

According to the compound-eye imaging apparatus according to the third aspect, the guidance is displayed which displays an image in which the plurality of frames indicating the image taking ranges of the plurality of plane images are superimposed so that the centers of the frames coincide with each other, and in which the image in the widest image taking range, in the plurality of plane images, is superimposed within the frame indicating the image taking range of the image in the widest image taking range, in the plurality of plane images. Thereby, the user can confirm what kind of image has been taken as the image in the widest image taking range, in the plurality of plane images.

In the compound-eye imaging apparatus according to a fourth aspect of the present invention, in the compound-eye imaging apparatus according to the second or third aspect, the display control device displays a frame indicating a limit of the image taking ranges of the plurality of plane images, so as to be superimposed on the figure in which the plurality of frames indicating the image taking ranges of the plurality of plane images are superimposed so that the centers of the frames coincide with each other.

According to the compound-eye imaging apparatus according to the fourth aspect, the guidance is displayed in which the frame indicating the limit of the image taking ranges of the plurality of plane images is superimposed on the figure in which the plurality of frames indicating the image taking ranges of the plurality of plane images are superimposed so that the centers of the frames coincide with each other. Thereby, the user can recognize the limit (a largest range and a smallest range) of the image taking range.

In the compound-eye imaging apparatus according to a fifth aspect of the present invention, in the compound-eye imaging apparatus according to any of the first to fourth aspects, a plurality of still images are taken as the plurality of plane images by one shutter release operation. Thereby, the plurality of still images in the different image taking ranges can be simultaneously taken.

The compound-eye imaging apparatus according to a sixth aspect of the present invention, in the compound-eye imaging apparatus according to any of the first to fourth aspects, further includes a switching device which inputs switching of the image to be displayed on the full screen of the display device, wherein the control device continuously obtains an image signal indicating a subject from each imaging element, and thereby takes a plurality of moving images as the plurality of plane images, and if the switching of the image is inputted by the switching device, the display control device displays an image other than the image in the narrowest image taking range, in the plurality of plane images, on the full screen of the display device, instead of the image in the narrowest image taking range. Thereby, the moving images in the different image taking ranges can be simultaneously taken.

Moreover, when the moving image is taken, it takes time to take the image, and thus the switching of the image to be displayed on the full screen of the display device during the image taking is enabled. Thereby, not only the image in the narrowest image taking range, but also the image other than the image in the narrowest image taking range can be confirmed.

A compound-eye imaging apparatus according to a seventh aspect of the present invention which includes a plurality of image pickup devices, each of which includes an image taking optical system including a zoom lens and includes an imaging element on which a subject image is formed by the image taking optical system, the compound-eye imaging apparatus being capable of taking subject images viewed from a plurality of viewpoints, as a stereoscopic image, includes an image taking mode setting device which sets a multi-image taking mode in which a plane image is taken in a different image taking range for each image pickup device of the plurality of image pickup devices; a lens moving device which, if the multi-image taking mode is set, moves the zoom lens in an optical axis direction so that zoom positions of the plurality of image pickup devices are set to be different for each image pickup device; a control device which, if the zoom lens has been moved by the lens moving device, takes a plurality of the plane images in the different image taking ranges via the plurality of image pickup devices; a display device which can display the plane image or the stereoscopic image; and a display control device which, if the multi-image taking mode has been set, arranges and displays the plurality of plane images in the different image taking ranges, on the display device.

According to the compound-eye imaging apparatus according to the seventh aspect, if an image taking mode of the compound-eye imaging apparatus which can take the subject images viewed from the plurality of viewpoints, as the stereoscopic image, is set to the multi-image taking mode in which the plurality of plane images in the different image taking ranges are taken, the zoom lens is moved in the optical axis direction so that the zoom positions of the plurality of image pickup devices are set to be different for each image pickup device, and the plurality of plane images in the different image taking ranges are taken by one shutter release operation. Thereby, the plurality of plane images in the different image taking ranges can be taken.

Moreover, according to the compound-eye imaging apparatus according to the seventh aspect, the plurality of plane images in the different image taking ranges which have been taken are arranged and displayed on the display device. Thereby, the user can recognize the image taking ranges of the plurality of plane images.

In the compound-eye imaging apparatus according to an eighth aspect of the present invention, in the compound-eye imaging apparatus according to the seventh aspect, the display control device displays a frame indicating the image taking range of an image in a narrowest image taking range, in the plurality of plane images, so as to be superimposed on an image in a widest image taking range, in the plurality of plane images.

According to the compound-eye imaging apparatus according to the eighth aspect, the plurality of plane images in the different image taking ranges which have been taken are arranged and displayed, and the frame indicating the image taking range of the image in the narrowest image taking range, in the plurality of plane images, is also displayed so as to be superimposed on the image in the widest image taking range, in the plurality of plane images. Thereby, the user can more clearly recognize the image taking ranges of the plurality of plane images.

In the compound-eye imaging apparatus according to a ninth aspect of the present invention, in the compound-eye imaging apparatus according to the seventh or eighth aspect, the control device takes a plurality of still images as the plurality of plane images by one shutter release operation, or continuously obtains an image signal indicating a subject from each imaging element and thereby takes a plurality of moving images as the plurality of plane images.

The compound-eye imaging apparatus according to a tenth aspect of the present invention, in the compound-eye imaging apparatus according to the first, second, third, fourth, fifth, sixth or eighth aspect, further includes an input device which inputs an instruction to change the image taking range, wherein the control device controls the lens moving device to change the zoom position of the image pickup device which takes the image in the narrowest image taking range, in the plurality of plane images, based on the input from the input device, and the display control device changes the image displayed on the display device, and also changes a size of the frame indicating the image taking range, in response to the change of the zoom position.

According to the compound-eye imaging apparatus according to the tenth aspect, if the instruction to change the image taking range is inputted, the zoom position of the image pickup device which takes the image in the narrowest image taking range, in the plurality of plane images, is changed, and in response to this change of the zoom position, the image displayed on the display device is changed, and the size of the frame indicating the image taking range is also changed. Thereby, the change and the display of the zoom position can be interlocked with each other, and operability for the user can be improved.

In the compound-eye imaging apparatus according to an eleventh aspect of the present invention, in the compound-eye imaging apparatus according to any of the first to tenth aspects, the lens moving device sets the zoom position of the image pickup device which takes the image in the widest image taking range, in the plurality of plane images, at a wide end.

According to the compound-eye imaging apparatus according to the eleventh aspect, the zoom position of the image pickup device which takes the image in the widest image taking range, in some plane images, is set at the wide end. Thereby, a wide side of the image taking range can be most widened.

In the compound-eye imaging apparatus according to a twelfth aspect of the present invention, in the compound-eye imaging apparatus according to any of the first to eleventh aspects, the display device can perform switching between a mode for displaying the stereoscopic image and a mode for displaying the plane image, and a switching device which, if the multi-image taking mode is set, switches a mode from the mode for displaying the stereoscopic image to the mode for displaying the plane image, is further included.

According to the compound-eye imaging apparatus according to the twelfth aspect, if the multi-image taking mode setting is set, a display mode of the display device is switched from the mode for displaying the stereoscopic image to the mode for displaying the plane image. Thereby, the user can be prevented from mistakenly recognizing that the mode is an image taking mode for taking a three-dimensional image.

The compound-eye imaging apparatus according to a thirteenth aspect of the present invention, in the compound-eye imaging apparatus according to any of the first to twelfth aspects, further includes a selection device which selects whether to automatically store all the plurality of plane images taken by the plurality of image pickup devices by one shutter release operation, or to store only a predetermined plane image; and a storage device which, if the automatic storage of all the plurality of plane images has been selected by the selection device, stores the plurality of plane images, and if the storage of only the predetermined plane image has been selected by the selection device, stores the predetermined plane image.

According to the compound-eye imaging apparatus according to the thirteenth aspect, if the automatic storage of all the plurality of plane images has been selected, the plurality of plane images are stored, and if the storage of only the predetermined plane image has been selected, the predetermined plane image is stored. Thereby, usability for the user can be improved.

The compound-eye imaging apparatus according to a fourteenth aspect of the present invention, in the compound-eye imaging apparatus according to any of the first to thirteenth aspects, further includes a flash light device which emits flash light to illuminate the subject; and a flash light control device which, if the multi-image taking mode is set, controls the flash light device to stop the light emission of the flash light device.

According to the compound-eye imaging apparatus according to the fourteenth aspect, if the multi-image taking mode is set, the light emission of the flash light device is stopped. Thereby, in the multi-image taking mode, a problem can be prevented from occurring due to the illumination from the flash.

According to the present invention, the plurality of plane images in the different image taking ranges can be taken by the plurality of image pickup devices, and also, the user can recognize the image taking ranges of the plurality of plane images and confirm the details of the subject.

### BRIEF DESCRIPTION OF THE DRAWINGS

FIGS. 1A and 1B are schematic diagrams of a compound-eye digital camera 1 of a first embodiment of the present invention, and FIG. 1A is a front view and FIG. 1B is a rear view;

FIG. 2 is a block diagram showing an electrical configuration of the compound-eye digital camera 1;

FIG. 3 is a flowchart showing a flow of an image taking process in a simultaneous tele/wide image taking mode;

FIG. 4 is an example of a live view image in the simultaneous tele/wide image taking mode;

FIG. 5 is an example of the live view image in the simultaneous tele/wide image taking mode;

FIG. 6 is an example of a display image in a focused state after S1 in the simultaneous tele/wide image taking mode;

FIG. 7 is an example of a post view image in the simultaneous tele/wide image taking mode;

FIG. 8 is a flowchart showing a flow of a recording process in the simultaneous tele/wide image taking mode;

FIG. 9 is a flowchart showing a flow of a process of transition from the simultaneous tele/wide image taking mode to another image taking mode;

FIG. 10 is another example of the live view image in the simultaneous tele/wide image taking mode;

FIG. 11 is another example of the live view image in the simultaneous tele/wide image taking mode;

FIG. 12 is an example of the display image when a moving image is taken in the simultaneous tele/wide image taking mode;

FIG. 13 is another example of the display image when the moving image is taken in the simultaneous tele/wide image taking mode;

FIGS. 14A and 14B are an example of switching the display image when the moving image is taken in the simultaneous tele/wide image taking mode;

FIG. 15 is another example of the post view image in the simultaneous tele/wide image taking mode;

FIG. 16 is an example of a mode screen;

FIG. 17 is a flowchart showing the flow of the recording process in the simultaneous tele/wide image taking mode in a compound-eye digital camera 2 of a second embodiment of the present invention; and

FIG. 18 is a flowchart showing the flow of the process of the transition from the simultaneous tele/wide image taking mode to another image taking mode in a compound-eye digital camera 3 of a third embodiment of the present invention.

### DETAILED DESCRIPTION OF THE PREFERRED EMBODIMENTS

Hereinafter, the best mode for carrying out a compound-eye imaging apparatus according to the present invention will be described in detail according to the accompanying drawings.

### First Embodiment

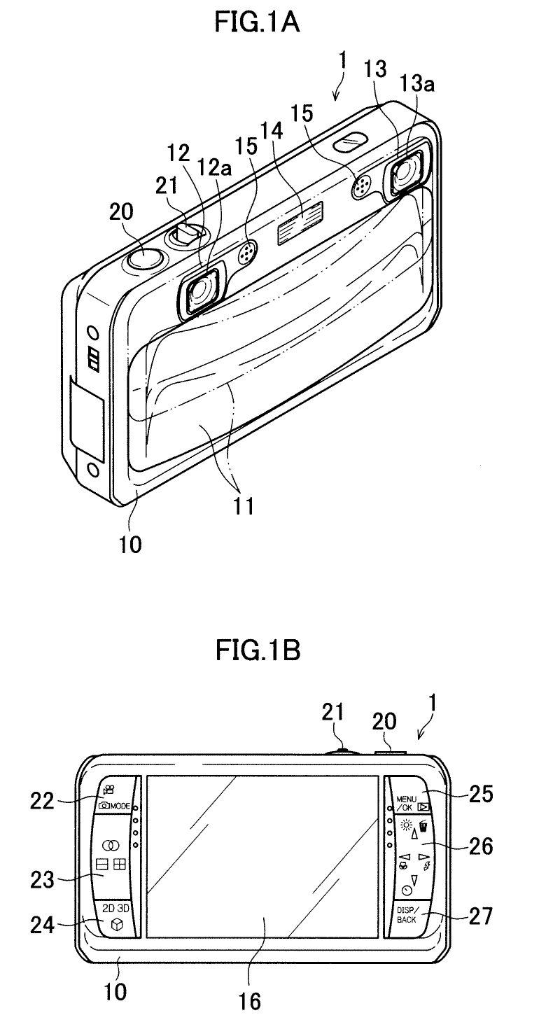

FIGS. 1A and 1B are schematic diagrams of a compound-eye digital camera 1 which is the compound-eye imaging apparatus according to the present invention, and FIG. 1A is a front view and FIG. 1B is a rear view. The compound-eye digital camera 1 is the compound-eye digital camera 1 including a plurality (two are illustrated in FIG. 1) of imaging systems, and can take a stereoscopic image of the same subject viewed from a plurality of viewpoints (two viewpoints of left and right are illustrated in FIG. 1), and a single viewpoint image (two-dimensional image). Moreover, the compound-eye digital camera 1 can also record and reproduce moving images and audio, in addition to still images.

A camera body 10 of the compound-eye digital camera 1 is formed in a generally rectangular parallelepiped box shape, and on the front face thereof, as shown in FIG. 1A, a barrier 11, a right imaging system 12, a left imaging system 13, a flash 14 and a microphone 15 are mainly provided. Moreover, on the upper surface of the camera body 10, a release switch 20 and a zoom button 21 are mainly provided.

On the other hand, on the back surface of the camera body 10, as shown in FIG. 1B, a monitor 16, a mode button 22, a parallax adjustment button 23, a 2D/3D switching button 24, a MENU/OK button 25, a cross button 26 and a DISP/BACK button 27 are provided.

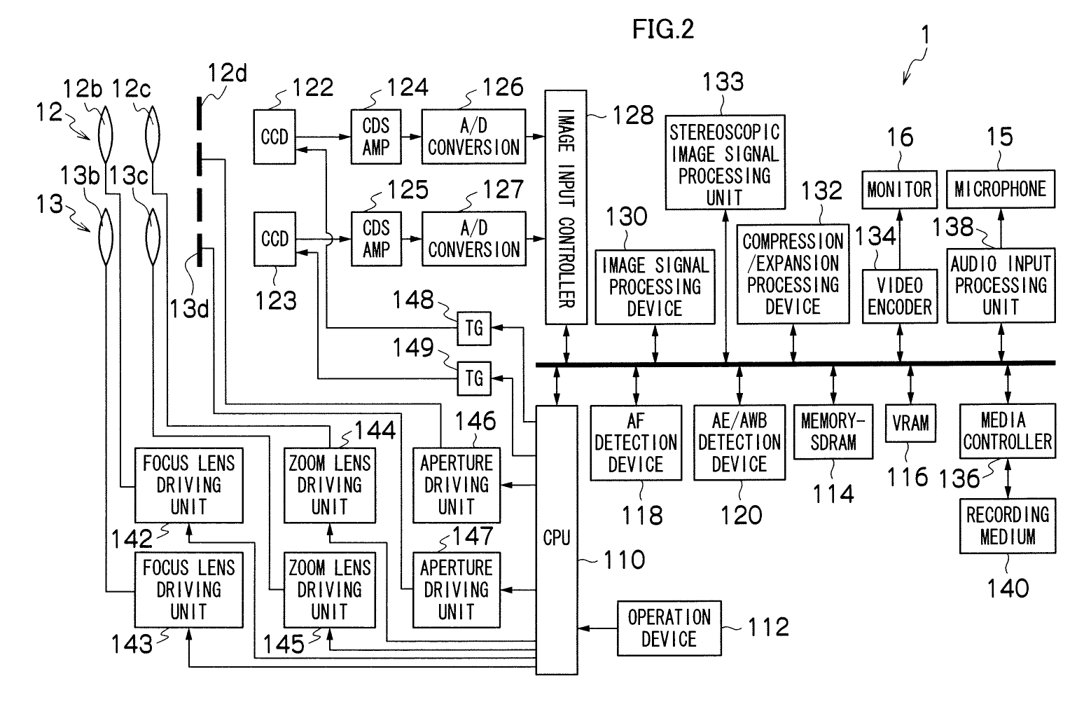

The barrier 11 is slidably mounted on the front surface of the camera body 10, and an open state and a closed state are switched by vertical sliding of the barrier 11. Usually, as shown by a dotted line in FIG. 1A, the barrier 11 is positioned at the upper end, that is, in the closed state, and objective lenses 12a and 13a and the like are covered by the barrier 11. Thereby, damage of the lens or the like is prevented. When the barrier 11 is slid and thereby the barrier is positioned at the lower end, that is, in the open state (see a solid line in FIG. 1A), the lenses and the like disposed on the front surface of the camera body 10 are exposed. When a sensor (not shown) recognizes that the barrier 11 is in the open state, power is turned ON by a CPU 110 (see FIG. 2), and images can be taken.

The right imaging system 12 which takes an image for the right eye and the left imaging system 13 which takes an image for the left eye are optical units including image taking lens groups having right-angle optical systems, and mechanical shutters with apertures 12d and 13d (see FIG. 2). The image taking lens groups of the right imaging system 12 and the left imaging system 13 are configured to mainly include the objective lenses 12a and 13a which capture light from the subject, prisms (not shown) which generally vertically bend optical paths entered from the objective lenses, zoom lenses 12c and 13c (see FIG. 2), focus lenses 12b and 13b (see FIG. 2), and the like.

The flash 14 is configured with a xenon tube, and light is emitted if needed, as in a case where an image of a dark subject is taken, or against the light, or the like.

The monitor 16 is a liquid crystal monitor which has a general aspect ratio of 4:3 and can perform color display, and can display both the stereoscopic image and a plane image. Although a detailed structure of the monitor 16 is not shown, the monitor 16 is a 3D monitor of a parallax barrier system, which includes a parallax barrier display layer on a surface thereof. The monitor 16 is used as a user interface display panel when various setting operations are performed, and is used as an electronic viewfinder when the image is taken.

In the monitor 16, a mode for displaying the stereoscopic image (3D mode) and a mode for displaying the plane image (2D mode) can be switched. In the 3D mode, a parallax barrier including a pattern, in which light transmissive portions and light blocking portions are alternately arranged at a predetermined pitch, is generated on the parallax barrier display layer of the monitor 16, and also, on an image display surface which is a lower layer thereof, strip-shaped image fragments representing left and right images are alternately arranged and displayed. In the 2D mode, or if the monitor 16 is used as the user interface display panel, nothing is displayed on the parallax barrier display layer, and on the image display surface which is the lower layer thereof, one image is directly displayed.

It should be noted that the monitor 16 is not limited to the parallax barrier system, and a lenticular system, an integral photography system using a micro lens array sheet, a holography system using an interference phenomenon, or the like may be employed. Moreover, the monitor 16 is not limited to the liquid crystal monitor, and an organic EL or the like may be employed.

The release switch 20 is configured with a switch of a two-stage stroke system including so-called “half pressing” and “full pressing”. In the compound-eye digital camera 1, when a still image is taken (for example, when a still image taking mode is selected via the mode button 22, or when the still image taking mode is selected from a menu), if this release switch 20 is half pressed, an image taking preparation process, that is, respective processes including AE (Automatic Exposure), AF (Auto Focus) and AWB (Automatic White Balance) are performed, and if this release switch 20 is fully pressed, image taking and recording processes of the image are performed. Moreover, when a moving image is taken (for example, when a moving image taking mode is selected via the mode button 22, or when the moving image taking mode is selected from the menu), if this release switch 20 is fully pressed, the image taking for the moving image is started, and if this release switch 20 is fully pressed again, the image taking is terminated.

The zoom button 21 is used for zoom operations of the right imaging system 12 and the left imaging system 13, and is configured with a zoom tele button 21T which instructs to zoom in a telephoto side, and a zoom wide button 21W which instructs to zoom in a wide-angle side.

The mode button 22 functions as an image taking mode setting device which sets an image taking mode of the digital camera 1, and the image taking mode of the digital camera 1 is set to various modes depending on a set position of this mode button 22. The image taking mode is separated into “moving image taking mode” which performs the moving image taking, and “still image taking mode” which performs the still image taking. “Still image taking mode” includes, for example, “automatic image taking mode” in which an aperture, a shutter speed and the like are automatically set by the digital camera 1, “face extraction-image taking mode” in which a person's face is extracted and the image taking is performed, “sports image taking mode” suitable for taking an image of a moving body, “landscape image taking mode” suitable for taking an image of a landscape, “night scene image taking mode” suitable for taking images of an evening scene and a night scene, “aperture priority-image taking mode” in which a scale of the aperture is set by a user and the shutter speed is automatically set by the digital camera 1, “shutter speed priority-image taking mode” in which the shutter speed is set by the user and the scale of the aperture is automatically set by the digital camera 1, “manual image taking mode” in which the aperture, the shutter speed and the like are set by the user, and the like.

The parallax adjustment button 23 is a button which electronically adjusts a parallax when the stereoscopic image is taken. When the upper side of the parallax adjustment button 23 is depressed, a parallax between the image taken by the right imaging system 12 and the image taken by the left imaging system 13 is increased by a predetermined distance, and when the lower side of the parallax adjustment button 23 is depressed, the parallax between the image taken by the right imaging system 12 and the image taken by the left imaging system 13 is decreased by the predetermined distance.

The 2D/3D switching button 24 is a switch which instructs to switch between a 2D image taking mode for taking a single viewpoint image, and a 3D image taking mode for taking a multi-viewpoint image.

The MENU/OK button 25 is used for invoking various setting screens (menu screens) for image taking and reproduction functions (MENU function), and is also used for confirming contents of selection, instructing to execute processes, and the like (OK function), and all adjustment items included in the compound-eye digital camera 1 are set. If the MENU/OK button 25 is depressed when the image is taken, for example, a setting screen for image quality adjustment or the like including an exposure value, a color tone, an ISO sensitivity, and the number of recorded pixels and the like is displayed on the monitor 16, and if the MENU/OK button 25 is depressed when the reproduction is performed, a setting screen for erasure of the image or the like is displayed on the monitor 16. The compound-eye digital camera 1 operates depending on conditions set on this menu screen.

The cross button 26 is a button which performs setting and selection of various kinds of menu, or performs zoom, and is provided so that pressing operations of the button in four directions of up, down, left and right can be performed, and each direction button is assigned with a function depending on a setting state of the camera. For example, when the image is taken, a left button is assigned with a function of switching ON/OFF of a macro function, and a right button is assigned with a function of switching a flash mode. Moreover, an up button is assigned with a function of changing brightness of the monitor 16, and a down button is assigned with a function of switching ON/OFF or time of a self-timer. Moreover, when the reproduction is performed, the right button is assigned with a frame advance function, and the left button is assigned with a frame return function. Moreover, the up button is assigned with a function of deleting the image being reproduced. Moreover, when various settings are performed, a function of moving a cursor displayed on the monitor 16 into each button direction is assigned.

The DISP/BACK button 27 functions as a button which instructs to switch the display of the monitor 16, and during the image taking, if this DISP/BACK button 27 is depressed, the display of the monitor 16 is switched as ON→framing guide display→OFF. Moreover, during the reproduction, if this DISP/BACK button 27 is depressed, the display is switched as normal reproduction→reproduction without text display→multi-reproduction. Moreover, the DISP/BACK button 27 functions as a button which instructs to cancel an input operation or return to a previous operation state.

FIG. 2 is a block diagram showing a main internal configuration of the compound-eye digital camera 1. The compound-eye digital camera 1 is configured to mainly have the CPU 110, an operation device (the release switch 20, the MENU/OK button 25, the cross button 26 and the like) 112, an SDRAM 114, a VRAM 116, an AF detection device 118, an AE/AWB detection device 120, the imaging elements 122 and 123, CDS/AMPs 124 and 125, A/D converters 126 and 127, an image input controller 128, an image signal processing device 130, a stereoscopic image signal processing unit 133, a compression/expansion processing device 132, a video encoder 134, a media controller 136, an audio input processing unit 138, a recording medium 140, focus lens driving units 142 and 143, zoom lens driving units 144 and 145, aperture driving units 146 and 147, and timing generators (TGs) 148 and 149.

The CPU 110 controls the entire operation of the compound-eye digital camera 1 in an integrated manner. The CPU 110 controls operations of the right imaging system 12 and the left imaging system 13. While the right imaging system 12 and the left imaging system 13 basically work with each other to perform the operations, each of the right imaging system 12 and the left imaging system 13 can also be individually operated. Moreover, the CPU 110 generates display image data in which two pieces of image data obtained by the right imaging system 12 and the left imaging system 13 are alternately displayed as strip-shaped image fragments on the monitor 16. When the display is performed in the 3D mode, the parallax barrier including the pattern, in which the light transmissive portions and the light blocking portions are alternately arranged at the predetermined pitch, is generated on the parallax barrier display layer, and also, on the image display surface which is the lower layer thereof, the strip-shaped image fragments representing the left and right images are alternately arranged and displayed, and thereby, stereoscopic viewing is enabled.

In the SDRAM 114, firmware which is a control program executed by this CPU 110, various data required for control, camera setting values, taken image data and the like are recorded.

The VRAM 116 is used as a work area of the CPU 110, and is also used as a temporary storage area for the image data.

The AF detection device 118 calculates a physical amount required for AF control, from an inputted image signal, according to a command from the CPU 110. The AF detection device 118 is configured to have a right imaging system-AF control circuit which performs the AF control based on an image signal inputted from the right imaging system 12, and a left imaging system-AF control circuit which performs the AF control based on an image signal inputted from the left imaging system 13. In the digital camera 1 of the present embodiment, the AF control is performed based on contrast of images obtained from the imaging elements 122 and 123 (so-called contrast AF), and the AF detection device 118 calculates a focus evaluation value indicating sharpness of the images from the inputted image signals. The CPU 110 detects a position at which the focus evaluation value calculated by this AF detection device 118 becomes a local maximum, and moves a focus lens group to the position. In other words, the focus lens group is moved by each predetermined step from a close range to infinity, the focus evaluation value is obtained at each position, a position at which the obtained focus evaluation value is maximum is set as a focused position, and the focus lens group is moved to the position.

The AE/AWB detection device 120 calculates physical amounts required for AE control and AWB control, from the inputted image signal, according to the command from the CPU 110. For example, as the physical amount required for the AE control, one screen is divided into a plurality of areas (for example, 16×16), and an integration value of R, G and B image signals is calculated for each divided area. The CPU 110 detects the brightness of the subject (subject luminance) based on the integration value obtained from this AE/AWB detection device 120, and calculates the exposure value (image taking EV value) suitable for the image taking. Then, an aperture value and the shutter speed are decided from the calculated image taking EV value and a predetermined program diagram. Moreover, as the physical amount required for the AWB control, one screen is divided into a plurality of areas (for example, 16×16), and an average integration value for each color of the R, G and B image signals is calculated for each divided area. The CPU 110 obtains R/G and B/G ratios for each divided area from an R integration value, a B integration value and a G integration value, which have been obtained, and performs light source type discrimination based on distribution or the like of the obtained values of R/G and B/G in R/G and B/G color spaces. Then, according to a white balance adjustment value suitable for a discriminated light source type, for example, gain values (white balance correction values) for the R, G and B signals in a white balance adjustment circuit are decided so that a value of each ratio is approximately 1 (that is, an RGB integration ratio becomes R:G:B≈1:1:1 in one screen).

The imaging elements 122 and 123 are configured with color CCDs in which R, G and B color filters of a predetermined color filter array (for example, a honeycomb array, a Bayer array) are provided. The imaging elements 122 and 123 receive subject lights formed by the focus lenses 12b and 13b, the zoom lenses 12c and 13c, and the like, and the light entered to this light receiving surface is converted into signal charges of an amount depending on an incident light amount, by each photodiode arranged on the light receiving surface. In photo charge accumulation and transfer operations in the imaging elements 122 and 123, an electronic shutter speed (photo charge accumulation time) is decided based on charge drain pulses inputted from the TGs 148 and 149, respectively.

In other words, if the charge drain pulses are inputted to the imaging elements 122 and 123, electric charges are not accumulated in the imaging elements 122 and 123 and are drained. On the other hand, when the charge drain pulses are not inputted to the imaging elements 122 and 123, the electric charges are not drained, and thus, electric charge accumulation, that is, exposure is started in the imaging elements 122 and 123. Imaging signals obtained by the imaging elements 122 and 123 are outputted to the CDS/AMPs 124 and 125, based on drive pulses given from the TGs 148 and 149, respectively.

The CDS/AMPs 124 and 125 perform a correlated double sampling process (a process for obtaining correct pixel data by obtaining a difference between a feed-through component level and a pixel signal component level included in the output signal for each one pixel from the imaging element, for the purpose of mitigating noise (particularly, thermal noise) or the like included in the output signal from the imaging element) for the image signals outputted from the imaging elements 122 and 123, perform amplification, and generate R, G and B analog image signals.

The A/D converters 126 and 127 convert the R, G and B analog image signals generated by the CDS/AMPs 124 and 125, into digital image signals.

The image input controller 128 includes a line buffer of a predetermined capacity, and according to the command from the CPU 110, the image signal of one image outputted from the CDS/AMP/AD converter is accumulated and recorded in the VRAM 116.

The image signal processing device 130 includes a synchronization circuit (a processing circuit which interpolates spatial shifts in color signals which are associated with a single CCD color filter array, and converts the color signals into synchronous signals), a white balance correction circuit, a gamma correction circuit, a contour correction circuit, a luminance/color difference signal generation circuit and the like, and according to the command from the CPU 110, applies a required signal process to the inputted image signal, and generates image data (YUV data) including luminance data (Y data) and color difference data (Cr, Cb data).

The compression/expansion processing device 132 applies a compression process of a predetermined format, to the inputted image data, and generates compressed image data, according to the command from the CPU 110. Moreover, the inputted compressed image data is applied with an expansion process of a predetermined format, and uncompressed image data is generated, according to the command from the CPU 110.

The video encoder 134 controls the display to the monitor 16. In other words, the image signal saved in the recording medium 140 or the like is converted into a video signal (for example, an NTSC signal, a PAL signal or a SCAM signal) for being displayed on the monitor 16, and outputted to the monitor 16, and also, predetermined text and graphic information is outputted to the monitor 16, if needed.

The media controller 136 records each image data applied with the compression process by the compression/expansion processing device 132, in the recording medium 140.

To the audio input processing unit 138, an audio signal which has been inputted to the microphone 15 and amplified by a stereo microphone amplifier (not shown) is inputted, and the audio input processing unit 138 performs a coding process for this audio signal.

The recording medium 140 is any of various recording media which are freely removable from the compound-eye digital camera 1, such as a semiconductor memory card represented by an xD Picture Card (registered trademark) and a SmartMedia (registered trademark), a portable small hard disk, a magnetic disk, an optical disk and a magnetic optical disk.

The focus lens driving units 142 and 143 move the focus lenses 12b and 13b in optical axis directions, respectively, and vary focus positions, according to the command from the CPU 110.

The zoom lens driving units 144 and 145 move the zoom lenses 12c and 13c in the optical axis directions, respectively, and vary focal lengths, according to the command from the CPU 110.

The mechanical shutters with apertures 12d and 13d are driven by iris motors of the aperture driving units 146 and 147, respectively, to thereby vary aperture amounts thereof and adjust incident light amounts for the imaging elements 122 and 123.

The aperture driving units 146 and 147 vary the aperture amounts of the mechanical shutters with apertures 12d and 13d, and adjust the incident light amounts for the imaging elements 122 and 123, respectively, according to the command from the CPU 110. Moreover, the aperture driving units 146 and 147 open and close the mechanical shutters with apertures 12d and 13d, and perform the exposure/light shielding for the imaging elements 122 and 123, respectively, according to the command from the CPU 110.

Operations of the compound-eye digital camera 1 configured as above will be described. When the barrier 11 is slid from the closed state to the open state, the compound-eye digital camera 1 is powered on, and the compound-eye digital camera 1 starts in the image taking mode. As the image taking mode, the 2D mode, and the 3D image taking mode for taking the stereoscopic image of the same subject viewed from the two viewpoints, can be set. Moreover, as the 2D mode, a normal 2D image taking mode in which only the right imaging system 12 or the left imaging system 13 is used to take the plane image, a simultaneous tele/wide image taking mode in which two two-dimensional images including an image in a wide range (a wide-side image) and an image of a subject which is zoomed up to a larger size (a tele-side image) are taken, and the like can be set. The image taking mode can be set from the menu screen which is displayed on the monitor 16 when the MENU/OK button 25 is depressed while the compound-eye digital camera 1 is driven in the image taking mode.

(1) Normal 2D Image Taking Mode

The CPU 110 selects the right imaging system 12 or the left imaging system 13 (the left imaging system 13 in the present embodiment), and starts the image taking for a live view image, with the imaging element 123 of the left imaging system 13. In other words, images are continuously imaged by the imaging element 123, image signals thereof are continuously processed, and image data for the live view image is generated.

The CPU 110 sets the monitor 16 in the 2D mode, sequentially adds the generated image data to the video encoder 134, converts the image data into a signal format for the display, and outputs the image data to the monitor 16. Thereby, live view display of the image captured by the imaging element 123 is performed on the monitor 16. If the input of the monitor 16 accommodates a digital signal, the video encoder 134 is not required. However, conversion into a signal form in accordance with an input specification of the monitor 16 is required.

The user performs framing, confirms the subject whose image is desired to be taken, confirms the taken image, and sets an image taking condition, while watching a live view image displayed on the monitor 16.

At the time of the image taking standby state, if the release switch 20 is half pressed, an S1ON signal is inputted to the CPU 110. The CPU 110 senses the S1ON signal, and performs AE light metering and the AF control. At the time of the AE light metering, the brightness of the subject is metered based on the integration value and the like of the image signal captured via the imaging element 123. This metered value (metered light value) is used for deciding the aperture value and the shutter speed of the mechanical shutter with aperture 13d at the time of actual image taking. Simultaneously, based on the detected subject luminance, it is determined whether or not the light emission of the flash 14 is required. If it is determined that the light emission of the flash 14 is required, pre-light emission of the flash 14 is performed, and a light emission amount of the flash 14 at the time of the actual image taking is decided based on reflected light thereof.

When the release switch 20 is fully pressed, an S2ON signal is inputted to the CPU 110. In response to this S2ON signal, the CPU 110 executes the image taking and recording processes.

First, the CPU 110 drives the mechanical shutter with aperture 13d via the aperture driving unit 147 based on the aperture value decided based on the metered light value, and also controls the charge accumulation time (a so-called electronic shutter) in the imaging element 123 so that the shutter speed decided based on the metered light value is realized.

Moreover, at the time of the AF control, the CPU 110 performs the contrast AF. In the contrast AF, the focus lens is sequentially moved to lens positions corresponding to the close range to the infinity, and also, an evaluation value, in which a high-frequency component of the image signal is integrated based on the image signal of an AF area of the image captured via the imaging element 123 at each lens position, is obtained from the AF detection device 118, the lens position at which this evaluation value reaches a peak is obtained, and the focus lens is moved to the lens position.

On this occasion, if the light emission of the flash 14 is performed, the light emission of the flash 14 is performed based on the light emission amount of the flash 14, which is obtained as a result of the pre-light emission.

The subject light enters the light receiving surface of the imaging element 123 via the focus lens 13b, the zoom lens 13c, the mechanical shutter with aperture 13d, an infrared cut filter (not shown), an optical low-pass filter (not shown) and the like.

The signal charges accumulated in each photodiode of the imaging element 123 are read out according to a timing signal added from the TG 149, sequentially outputted as voltage signals (image signals) from the imaging element 123, and inputted to the CDS/AMP 125.

The CDS/AMP 125 performs the correlated double sampling process for a CCD output signal based on a CDS pulse, and amplifies the image signal outputted from a CDS circuit, with a gain for setting image taking sensitivity, which is added from the CPU 110.

The analog image signal outputted from the CDS/AMP 125 is converted into the digital image signal in the A/D converter 127, and this converted image signal (R, G and B RAW data) is transferred to the SDRAM 114, and stored in the SDRAM 114 once.

The R, G and B image signals read from the SDRAM 114 are inputted to the image signal processing device 130. In the image signal processing device 130, white balance adjustment is performed by applying a digital gain to each of the R, G and B image signals by the white balance adjustment circuit, a tone conversion process depending on gamma characteristics is performed by the gamma correction circuit, and a synchronization process for interpolating the spatial shifts in the respective color signals which are associated with the single CCD color filter array, and causing the color signals to be in phase, is performed. Synchronized R, G and B image signals are further converted into a luminance signal Y and color difference signals Cr and Cb (YC signal) by a luminance/color difference data generation circuit, and the Y signal is applied with a contour enhancement process by the contour correction circuit. The YC signal processed in the image signal processing device 130 is stored in the SDRAM 114 again.

The YC signal stored in the SDRAM 114 as described above is compressed by the compression/expansion processing device 132, and is recorded as an image file in a predetermined format, in the recording medium 140 via the media controller 136. Still image data is stored as an image file conforming to the Exif standard in the recording medium 140. An Exif file has a region which stores main image data, and a region which stores reduced image (thumbnail image) data. From the main image data obtained by the image taking, a thumbnail image of a defined size (for example, 160×120 or 80×60 pixels or the like) is generated through a pixel thinning process and other necessary data processing. The thumbnail image generated in this way is written with the main image into the Exif file. Moreover, tag information, such as image taking date and time, the image taking condition, and face detection information, is attached to the Exif file.

If switching from the normal 2D image taking mode to another image taking mode (transition of the image taking mode) has been inputted, the CPU 110 determines whether or not the image taking mode of a transition destination is the simultaneous tele/wide image taking mode or the 3D image taking mode. If the image taking mode of the transition destination is the simultaneous tele/wide image taking mode, the CPU 110 holds the monitor 16 in the 2D mode, and starts the process in another image taking mode. If the image taking mode of the transition destination is the 3D mode, the CPU 110 switches the monitor 16 into the 3D mode, and starts the process in another image taking mode.

(2) Simultaneous Tele/Wide Image Taking Mode

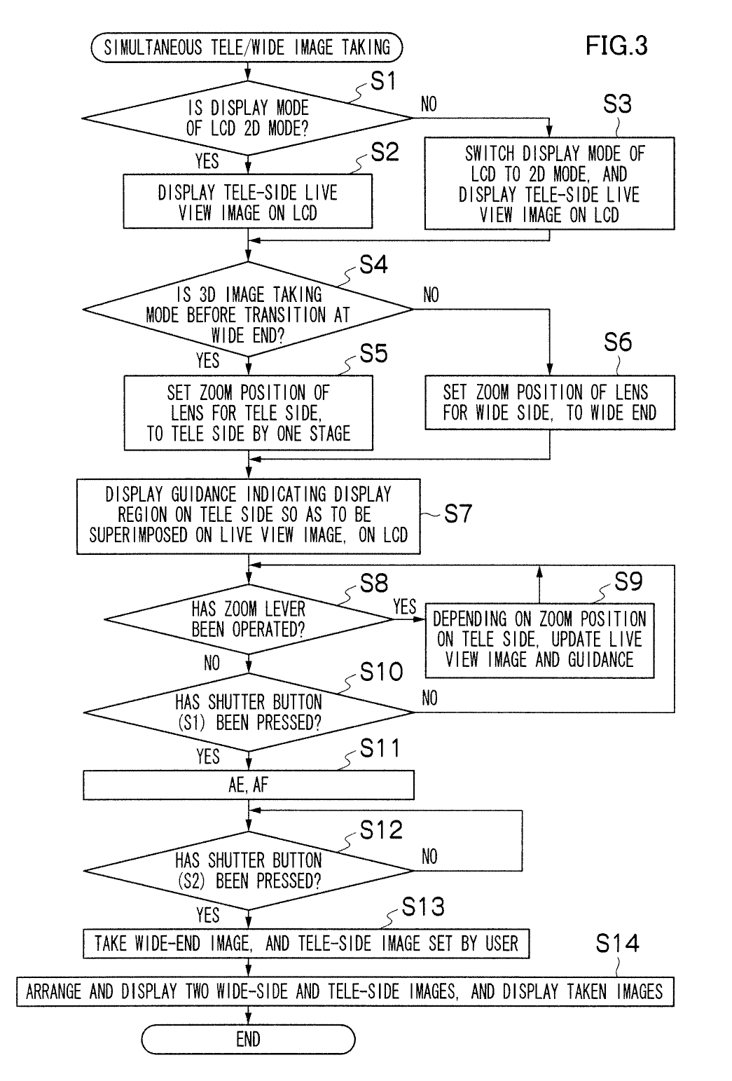

FIG. 3 is a flowchart showing a flow of an image taking process in the simultaneous tele/wide image taking mode. Hereinafter, the description is made on the assumption that the wide-side image is taken by the right imaging system 12 and the tele-side image is taken by the left imaging system 13. Of course, the tele-side image may be taken by the right imaging system 12, and the wide-side image may be taken by the left imaging system 13.

When the simultaneous tele/wide image taking mode is set, the image taking for the live view image is started by the right imaging system 12 and the left imaging system 13. In other words, the images are continuously imaged by the imaging elements 122 and 123 and continuously processed, and the image data for the live view image is generated. If image taking ranges (zoom angles of view) of the imaging elements 122 and 123 are different, brightness of the lenses of the right imaging system 12 and the left imaging system 13 vary due to the difference between the zoom angles of view. Moreover, if the zoom angles of view are different, the imaging elements 122 and 123 are taking images of different subjects, and therefore, it is difficult to perform appropriate flash light adjustment for two subjects via one flash light emission. Thus, if the simultaneous tele/wide image taking mode has been set, the CPU 110 may disable the light emission of the flash 14. Thereby, a problem in that the subject becomes too bright by being illuminated by the flash and whiteout occurs, and the like can be prevented from occurring.

The CPU 110 determines whether or not the monitor 16 is in the 2D mode (step S1). If the monitor 16 is in the 2D mode (YES in step S1), the CPU 110 outputs the image data for the live view image which has been taken by the left imaging system 13, via the video encoder 134 to the monitor 16 (step S2). If the monitor 16 is not in the 2D mode (NO in step S1), the CPU 110 switches the monitor 16 from the 3D mode to the 2D mode, and outputs the image data for the live view image which has been taken by the left imaging system 13, via the video encoder 134 to the monitor 16 (step S3). Thereby, a tele-side live view image taken by the left imaging system 13 is displayed on a full screen of the monitor 16. Therefore, the user can be prevented from misunderstanding that the mode is the 3D image taking mode because stereoscopic display of the image is wrongly performed or the like.

The CPU 110 determines whether or not zoom positions of the right imaging system 12 and the left imaging system 13 are at a wide end (step S4). If the zoom positions of the right imaging system 12 and the left imaging system 13 are at the wide end (YES in step S4), the CPU 110 moves the zoom position of the left imaging system 13 which takes the tele-side image, to a tele side by one stage via the zoom lens driving unit 145 (step S5). If the zoom positions of the right imaging system 12 and the left imaging system 13 are not at the wide end (NO in step S4), the CPU 110 moves the zoom position of the right imaging system 12 which takes a wide-image, to the wide end via the zoom lens driving unit 144 (step S6). Thereby, the zoom positions of the zoom lens 12c of the right imaging system 12 and the zoom lens 13c of the left imaging system 13 are set to be different from each other, and two images in different image taking ranges can be taken. In the present embodiment, the zoom lens 12c is positioned at the wide end, and the zoom lens 13c is positioned nearer to the tele side than to the wide end by at least one stage.

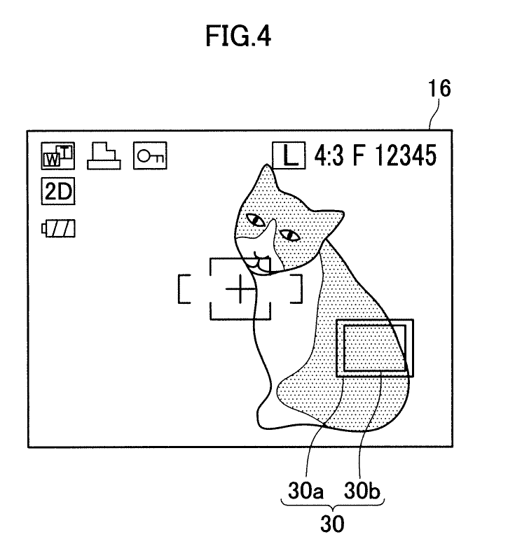

The CPU 110 generates guidance 30 (see FIG. 4) based on the positions of the zoom lens 12c and the zoom lens 13c after steps S5 and S6 have been performed. The guidance 30 is a figure in which a frame 30a indicating the image taking range of the wide-image and a frame 30b indicating the image taking range of a tele-image are superimposed so that centers of the frame 30a and the frame 30b coincide with each other. The CPU 110 outputs the generated guidance 30 via the video encoder 134 to the monitor 16 (step S7).

Thereby, as shown in FIG. 4, the guidance 30 is displayed so as to be superimposed on the tele-side live view image. Therefore, the user can recognize the image taking ranges of a plurality of plane images at a glance, and can know what kind of image is taken as the tele-side image, and in addition, what kind of image is taken as the wide-side image. Moreover, since the figure in which the frame 30a indicating the image taking range of the wide-image and the frame 30b indicating the image taking range of the tele-image are superimposed so that the centers of the frame 30a and the frame 30b coincide with each other, is outputted as the guidance, the user can recognize a ratio of the image taking range of the tele-side image to the image taking range of the wide-side image, at a glance. Furthermore, since the tele-side live view image is displayed on the full screen of the monitor 16, the user can even recognize details of the subject by watching the tele-side image.

Moreover, as shown in FIG. 4, an icon representing the simultaneous tele/wide image taking mode is displayed on the upper left of the monitor 16. Therefore, the user can recognize that two plane images (the tele-side and wide-side images) in the different image taking ranges are being taken. Furthermore, generally on the center of the monitor 16, a target mark indicating that a still image is taken is displayed.

The CPU 110 determines whether or not the zoom button 21 has been operated by the user (step S8). If the zoom button 21 has been operated (YES in step S8), in response to the operation of the zoom button 21, the CPU 110 moves the zoom position of the zoom lens 13c of the left imaging system 13, via the zoom lens driving unit 145, and outputs the image data for the live view image which has been taken by the left imaging system 13, via the video encoder 134 to the monitor 16. Thereby, the live view image to be displayed on the monitor 16 is updated. Moreover, the CPU 110 updates the guidance 30 based on the moved zoom position.

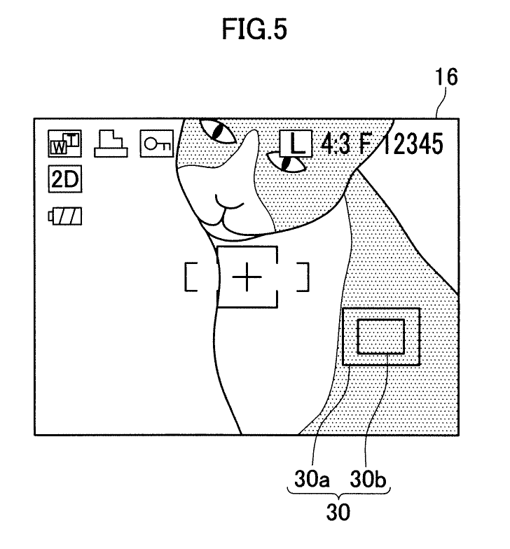

For example, if an instruction indicating movement of the zoom position to the tele side by two stages has been inputted via the operation of the zoom button 21, as shown in FIG. 5, the live view image after the zoom position has been moved to the tele side by two stages is displayed on the monitor 16, and also, the frame 30b indicating the image taking range of the tele-image is reduced in the guidance 30. In this way, since the movement of the zoom position is performed after the display on the monitor 16 has become the tele-side live view image display, change and the display of the zoom position can be interlocked with each other, and operability can be improved without causing the user to have a feeling of strangeness at the time of the zoom operation.

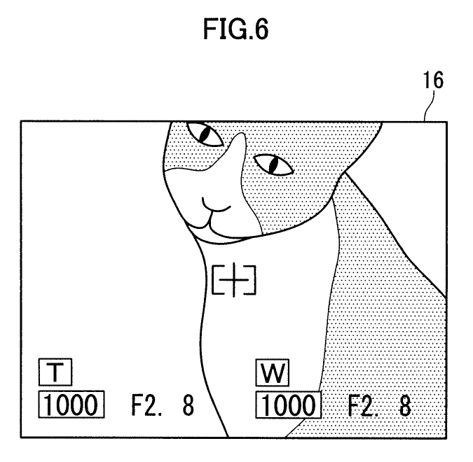

If the zoom button 21 has not been operated (NO in step S8), the CPU 110 determines whether or not the release switch 20 has been half pressed, that is, whether or not the S1ON signal has been inputted to the CPU 110 (step S10). If the release switch 20 has not been half pressed (NO in step S10), step S8 is performed again. If the release switch 20 has been half pressed (YES in step S10), the CPU 110 performs the AE light metering and the AF control for each of the right imaging system 12 and the left imaging system 13 (step S11). Since the AE light metering and the AF control are the same as the normal 2D image taking mode, a detailed description thereof is omitted. If a focused state is set once, the CPU 110 stops lens driving of the focus lenses 12b and 13b and performs focus lock. Then, as shown in FIG. 6, the CPU 110 displays the tele-side image in the focused state, on the full screen of the monitor 16.

The CPU 110 determines whether or not the release switch 20 has been fully pressed, that is, whether or not the S2ON signal has been inputted to the CPU 110 (step S12). If the release switch 20 has not been fully pressed (NO in step S12), step S12 is performed again. If the release switch 20 has been fully pressed (YES in step S12), the CPU 110 obtains the signal charges accumulated in each photodiode of the imaging elements 122 and 123 to generate the image data (step S13). Since a process in step S13 is the same as the normal 2D image taking mode, a description thereof is omitted.

In the present embodiment, only the image data of the tele-side image and the wide-side image needs to be obtained when the S2ON signal is inputted once, and the tele-side image and the wide-side image may be simultaneously exposed and processed, or may be sequentially exposed and processed.

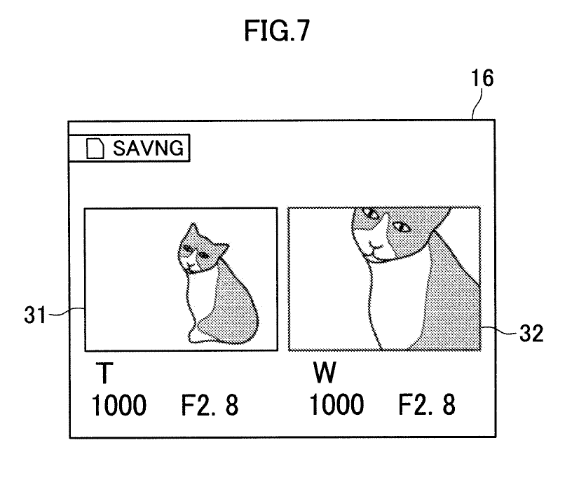

As shown in FIG. 7, the CPU 110 generates an image in which a wide-side image 31 and a tele-side image 32 which have been taken in step S13 are arranged in the same size, and displays the image as a so-called post view on the monitor 16 (step S14). Thereby, the wide-side image and the tele-side image which have been taken can be confirmed after being taken and before being recorded.

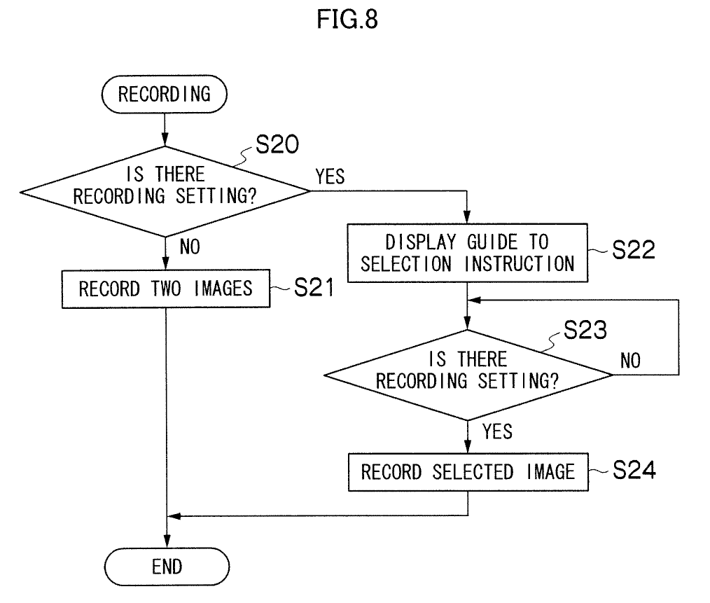

FIG. 8 is a flowchart showing a flow of the recording process for the images taken in the simultaneous tele/wide image taking mode. Setting related to the recording process can be performed from the menu screen which is displayed on the monitor 16 when the MENU/OK button 25 is depressed while the compound-eye digital camera 1 is driven in the image taking mode. In the present embodiment, it is possible to set whether or not to select the image before being recorded.

The CPU 110 determines whether or not the setting related to the recording process has been performed (step S20). If the setting has not been performed (NO in step S20), the wide-side image and the tele-side image are automatically recorded (step S21).

If the setting has been recorded (YES in step S20), the CPU 110 performs display which guides to the selection of the image, on the monitor 16 (step S22), and determines whether or not the selection of the image has been inputted (step S23). The selection of the image is performed by using the operation unit 112 to select the image on a selection screen (not shown). If the selection of the image has not been inputted (NO in step S23), step S23 is performed again. If the selection of the image has been inputted (YES in step S23), the image whose selection has been inputted is recorded (step S24).

Thereby, it is possible to select whether to automatically record the images or to record only a desired image, based on the selection made by the user, and usability for the user is improved. It should be noted that the recording process for the images is a method similar to the normal 2D image taking mode, and thus, a description thereof is omitted.

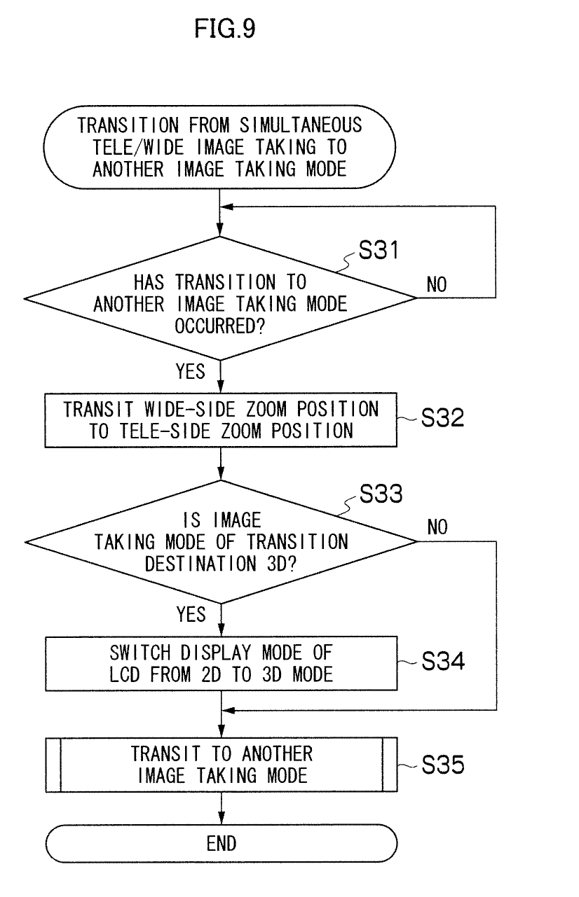

FIG. 9 is a flowchart showing a flow of a process when the mode is switched from the simultaneous tele/wide image taking mode to another image taking mode.

The CPU 110 determines whether or not the setting has been changed to another image taking mode (the normal 2D image taking mode, the 3D image taking mode or the like) (whether or not transition to another image taking mode has occurred) via the operation of the MENU/OK button 25 or the like (step S31). If the transition to another image taking mode has not occurred (NO in step S31), step S31 is performed again.

If the transition to another image taking mode has occurred (YES in step S31), the CPU 110 moves the zoom position of the right imaging system 12 which takes the wide-side image, to the zoom position of the left imaging system 13 which takes the tele-side image, via the zoom lens driving unit 144 (step S32). Since the image taking mode in which the zoom positions of the right imaging system 12 and the left imaging system 13 are different is only the simultaneous tele/wide image taking mode, for subsequent processes, whatever image taking mode is set after the transition, the zoom positions of the right imaging system 12 and the left imaging system 13 need to be set at the same position. However, since the tele-side image has been displayed as the live view image on the monitor 16, if the zoom position of the left imaging system 13 is moved, the display on the monitor 16 is changed, and the user has the feeling of strangeness. Therefore, such a defect can be prevented by moving the zoom position of the right imaging system 12.

The CPU 110 determines whether or not the image taking mode of the transition destination is the 3D image taking mode (step S33). If the image taking mode of the transition destination is the 3D image taking mode (YES in step S33), the CPU 110 switches the monitor 16 into the 3D mode (step S34), and starts the process in another image taking mode (step S35). If the image taking mode of the transition destination is not the 3D image taking mode (NO in step S34), the monitor 16 is held in the 2D mode, and the process in another image taking mode is started (step S35).

(3) In Case where 3D Image Taking Mode is Set

The image taking for the live view image is started by the imaging element 122 and the imaging element 123. In other words, the same subject is continuously imaged by the imaging element 122 and the imaging element 123, the image signals thereof are continuously processed, and stereoscopic image data for the live view image is generated. The CPU 110 sets the monitor 16 in the 3D mode, and the generated image data is sequentially converted into the signal format for the display, and is outputted to the monitor 16, respectively, by the video encoder 134.

The generated image data is sequentially added to the video encoder 134, converted into the signal format for the display, and outputted to the monitor 16. Thereby, the through display of the stereoscopic image data for the live view image is performed on the monitor 16.

The user performs the framing, confirms the subject whose image is desired to be taken, confirms the taken image, and sets the image taking condition, while watching the live view image displayed on the monitor 16.

At the time of the image taking standby state, if the release switch 20 is half pressed, the S1ON signal is inputted to the CPU 110. The CPU 110 senses the S1ON signal, and performs the AE light metering and the AF control. The AE light metering is performed by one of the right imaging system 12 and the left imaging system 13 (the left imaging system 13 in the present embodiment). Moreover, the AF control is performed by each of the right imaging system 12 and the left imaging system 13. Since the AE light metering and the AF control are the same as the normal 2D image taking mode, the detailed description thereof is omitted.

When the release switch 20 is fully pressed, the S2ON signal is inputted to the CPU 110. In response to this S2ON signal, the CPU 110 executes the image taking and recording processes. Since a process for generating the image data taken by each of the right imaging system 12 and the left imaging system 13 is the same as the normal 2D image taking mode, a description thereof is omitted.

From two pieces of the image data generated by the CDS/AMPs 124 and 125, respectively, two pieces of compressed image data are generated according to a method similar to the normal 2D image taking mode. The two pieces of compressed image data are recorded in a state of being associated with each other in the recording medium 140.

If switching from the 3D image taking mode to another image taking mode has been inputted, the image taking mode of the transition destination is the normal 2D image taking mode or the simultaneous tele/wide image taking mode. Therefore, the CPU 110 switches the monitor 16 into the 2D mode, and starts the process in another image taking mode.

When the mode of the compound-eye digital camera 1 is set to a reproduction mode, the CPU 110 outputs the command to the media controller 136 to read the image file which has been recorded last in the recording medium 140.

The compressed image data in the read image file is added to the compression/expansion processing device 132, expanded into uncompressed luminance/color difference signals, converted into the stereoscopic image by the stereoscopic image signal processing unit 133, and then outputted via the video encoder 134 to the monitor 16. Thereby, the image recorded in the recording medium 140 is reproduced and displayed on the monitor 16 (the reproduction of one image).

In the reproduction of one image, for the image taken in the normal 2D image taking mode, the image is displayed in the 2D mode on the full screen of the monitor 16, and for the images taken in the simultaneous tele/wide image taking mode, as shown in FIG. 7, the tele-side image and the wide-side image are displayed side by side, and for the image taken in the 3D mode, the image is displayed in the 3D mode on the full screen of the monitor 16. For the images taken in the simultaneous tele/wide image, taking mode, based on the selection made by the user, only one of the tele-side image and the wide-side image can also be displayed in the 2D mode on the full screen of the monitor 16, or the tele-side image and the guidance 30 can also be displayed.

The frame advance of the image is performed by left and right key operations of the cross button 26, and if a right key of the cross button 26 is depressed, a next image file is read from the recording medium 140, and reproduced and displayed on the monitor 16. Moreover, if a left key of the cross button is depressed, a previous image file is read from the recording medium 140, and reproduced and displayed on the monitor 16.

While the image reproduced and displayed on the monitor 16 is confirmed, if needed, the image recorded in the recording medium 140 can be erased. The erasure of the image is performed by depressing the MENU/OK button 25 in a state where the image is reproduced and displayed on the monitor 16.

According to the present embodiment, not only the stereoscopic image, but also the plurality of plane images in the different image taking ranges can be taken.

Moreover, according to the present embodiment, the image taking range of the tele-side image and the image taking range of the wide-side image can be known by looking at the guidance. Moreover, since the tele-side live view image is displayed on the full screen of the monitor, the user can even recognize the details of the subject by watching the tele-side image.

Moreover, in the present embodiment, it is possible to select whether to automatically record the images or to record only the desired image, and the usability can be improved.

It should be noted that, in the present embodiment, as shown in FIG. 4, although the guidance 30, which is the figure in which the frame 30a indicating the image taking range of the wide-image and the frame 30b indicating the image taking range of the tele-image are superimposed so that the centers of the frame 30a and the frame 30b coincide with each other, is displayed so as to be superimposed on the tele-side live view image, the guidance is not limited to this form.

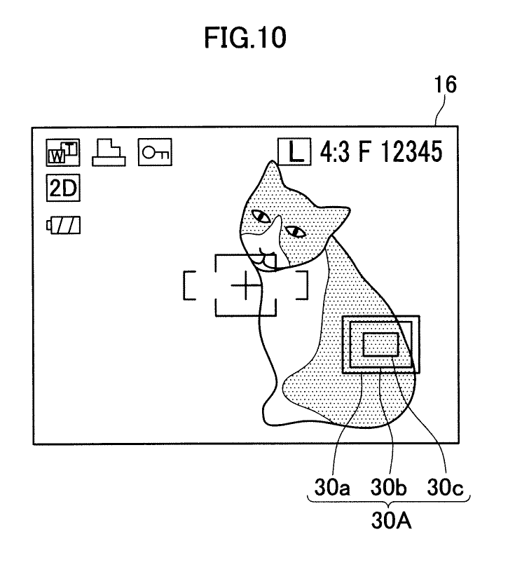

For example, as shown in FIG. 10, in addition to the frame 30a indicating the image taking range of the wide-image and the frame 30b indicating the image taking range of the tele-image, a frame 30c indicating a minimum image taking range of the tele-image, that is, the image taking range at a position at a tele end, may be superimposed so that centers of the frame 30a, the frame 30b and the frame 30c coincide with one another. Thereby, the user can recognize a limit (a largest range and a smallest range) of the image taking range.

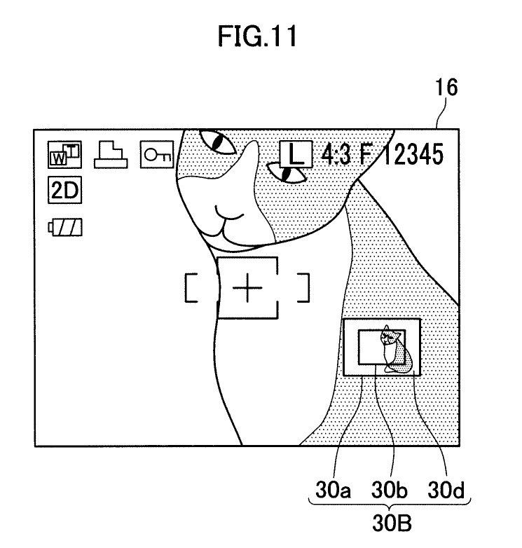

Moreover, as shown in FIG. 11, the tele-side image may be displayed on the full screen of the monitor 16, and then, a wide-side image 30d (which may be the live view image or the image taken when the image taking is started) may be displayed in a reduced size, within the frame 30a indicating the image taking range of the wide-image. Moreover, the frame 30a indicating the image taking range of the wide-image and the frame 30b indicating the image taking range of the tele-image may be displayed in parallel. Thereby, the user can confirm what kind of image has been taken as an image in a widest image taking range, in the plurality of plane images.

Moreover, in the present embodiment, as the display of the live view image, the tele-side image and the guidance 30 are displayed. However, the display of the tele-side image and the guidance 30 is not limited to the live view image. For example, at the time of the focus lock after S1, the image captured in the focused state by the imaging element 123 and the guidance 30 may be displayed.

Moreover, when the moving image is taken, the tele-side image and the guidance 30 may be displayed. When the live view image is taken, if the release switch 20 is pressed long, the CPU 110 continuously takes the images at the same frame rate and at the same timing by the imaging elements 122 and 123, and thereby simultaneously takes the moving images by the right imaging system 12 and the left imaging system 13.

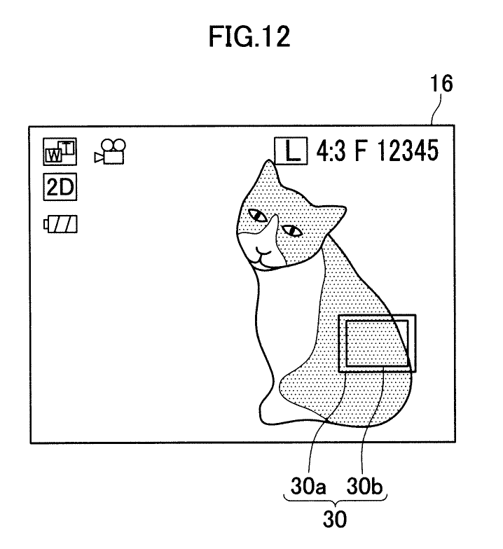

FIG. 12 is an example of the display on the monitor 16 when the moving image is taken. When the moving image is taken, similarly to when the still image is taken, the icon representing the simultaneous tele/wide image taking mode is displayed, and an icon representing the image taking for the moving image is also displayed on the monitor 16. It should be noted that the target mark is not displayed in this case.

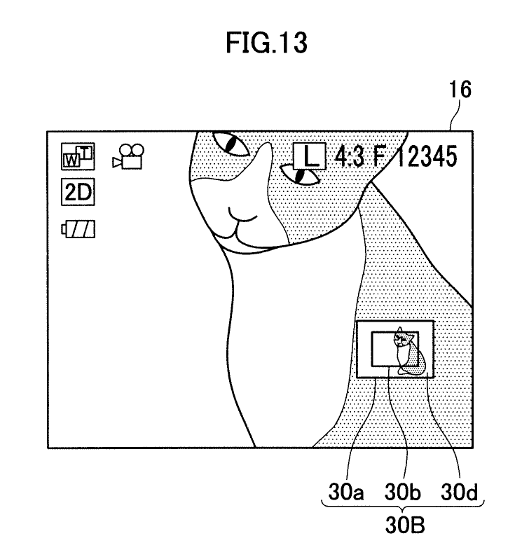

Also when the moving image is taken, similarly to when the live view image is taken, in response to the zoom operation, the zoom lens 13c of the left imaging system 13 which takes the tele-side image is moved, and along with the movement, the image to be displayed on the monitor 16 is also changed (see FIG. 13). Moreover, as shown in FIG. 13, the wide-side image 30d may be displayed in the reduced size, within the frame 30a indicating the image taking range of the wide-image.

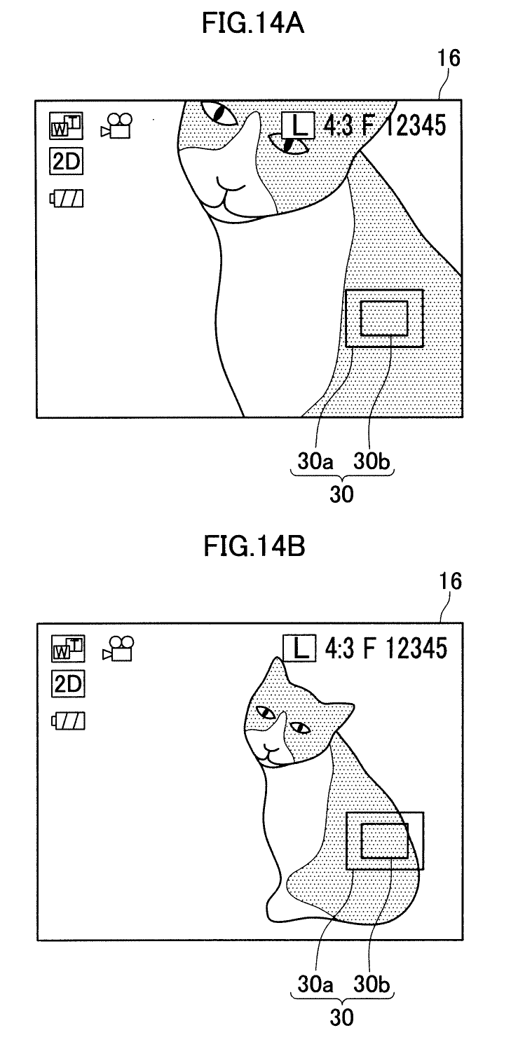

When the moving image is taken, an image taking operation continues only for a predetermined period. Therefore, the image to be displayed on the monitor 16 can also be switched while the moving image is taken. If an instruction indicating the switching of the display image is inputted via the operation device such as the cross button 26, the CPU 110 detects this instruction, and displays an image other than the image being currently displayed, on the monitor 16. If no operation is performed, as shown in FIG. 14A, the tele-side image (in the present embodiment, the image taken by the left imaging system 13) is displayed on the monitor 16. In this state, if the CPU 110 detects the image switching instruction, wide-side image data taken by the right imaging system 12 is outputted via the video encoder 134 to the monitor 16. Thereby, as shown in FIG. 14B, the wide-side image is displayed on the monitor 16. In this way, when the moving image is taken, the (main display) image displayed on the full screen of the monitor 16 can be switched, and the image being taken by each image pickup device can be confirmed. The switching of this main display may also be able to be performed when the live view image is taken.

Moreover, in the present embodiment, as shown in FIG. 7, immediately after the image taking, the image in which the wide-side image 31 and the tele-side image 32 are arranged in the same size is displayed as the so-called post view on the monitor 16. However, the post view is not limited to this form.

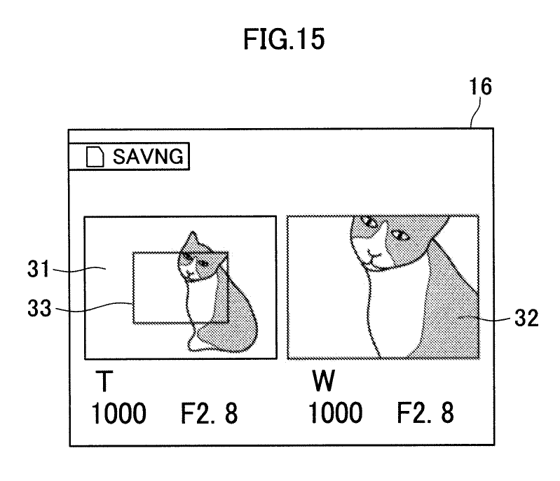

For example, as shown in FIG. 15, the wide-side image 31 and the tele-side image 32 may be arranged in the same size, and then, a frame 33 indicating the image taking range of the tele-side image may be displayed so as to be superimposed on the wide-side image 31. Moreover, the wide-side image 31 and the tele-side image 32 do not need to be arranged in the same size, and may be arranged in any direction of left, right, up or down.

Moreover, the tele-side image and the guidance 30 may be displayed as the so-called post view. Also in the case of taking the moving image, the image in which the wide-side image 31 and the tele-side image 32 are arranged in the same size may be displayed as the so-called post view on the monitor 16, or the tele-side image and the guidance 30 may be displayed.

Moreover, in the present embodiment, while the image in which the wide-side image 31 and the tele-side image 32 are arranged in the same size is displayed as the so-called post view on the monitor 16, the display of the wide-side image and the tele-side image in parallel is not limited to the post view. For example, a wide-side live view image taken by the right imaging system 12 and a tele-side live view image taken by the left imaging system 13 may be arranged and displayed as the live view image on the monitor 16. Moreover, at the time of the focus lock after S1, the image captured by the imaging element 122 and the image captured by the imaging element 123, in the focused state, may be arranged, and the images may be displayed after S1. Moreover, when the moving image is taken, a wide-side moving image taken by the right imaging system 12 and a tele-side moving image taken by the left imaging system 13 may be arranged and displayed in parallel.

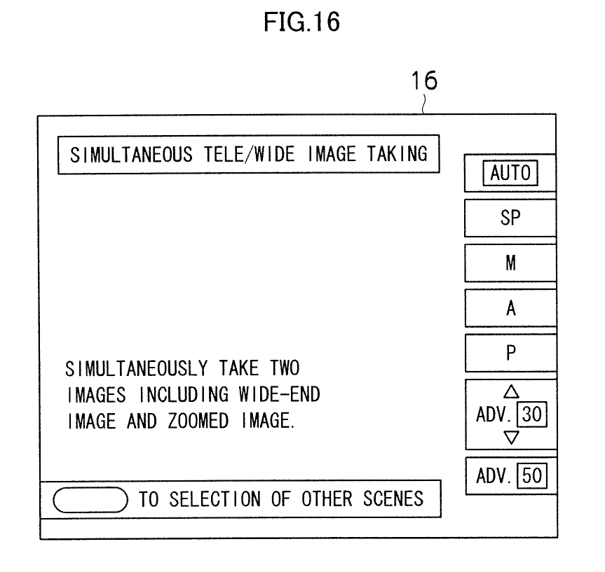

Moreover, in the present embodiment, at the time of the simultaneous tele/wide image taking mode, the monitor 16 is set to the 2D mode before the live view image is taken. However, as shown in FIG. 16, the menu screen in the case where the transition of the image taking mode from the 3D image taking mode to the 2D image taking mode is set may be displayed on the entire monitor 16. Since the menu screen is displayed in a two-dimensional manner, an effect similar to the case where the monitor 16 is previously set to the 2D mode can be obtained.

### Second Embodiment

In the first embodiment of the present invention, when the simultaneous tele/wide image taking mode has been set, the zoom positions of the right imaging system 12 and the left imaging system 13 are decided, and then the monitor 16 is set to the 2D mode. However, the order thereof is not limited thereto.

A second embodiment of the present invention is a mode in which when the simultaneous tele/wide image taking mode has been set, the monitor 16 is set to the 2D mode, and then the zoom positions of the right imaging system 12 and the left imaging system 13 are decided. A compound-eye digital camera 2 of the second embodiment is different from the compound-eye digital camera 1 of the first embodiment, only in the image taking process in the simultaneous tele/wide image taking mode, and thus, only the image taking process in the simultaneous tele/wide image taking mode will be described, and descriptions of other portions are omitted. Moreover, the same portions as those of the first embodiment are assigned with the same reference numerals, and descriptions thereof are omitted.

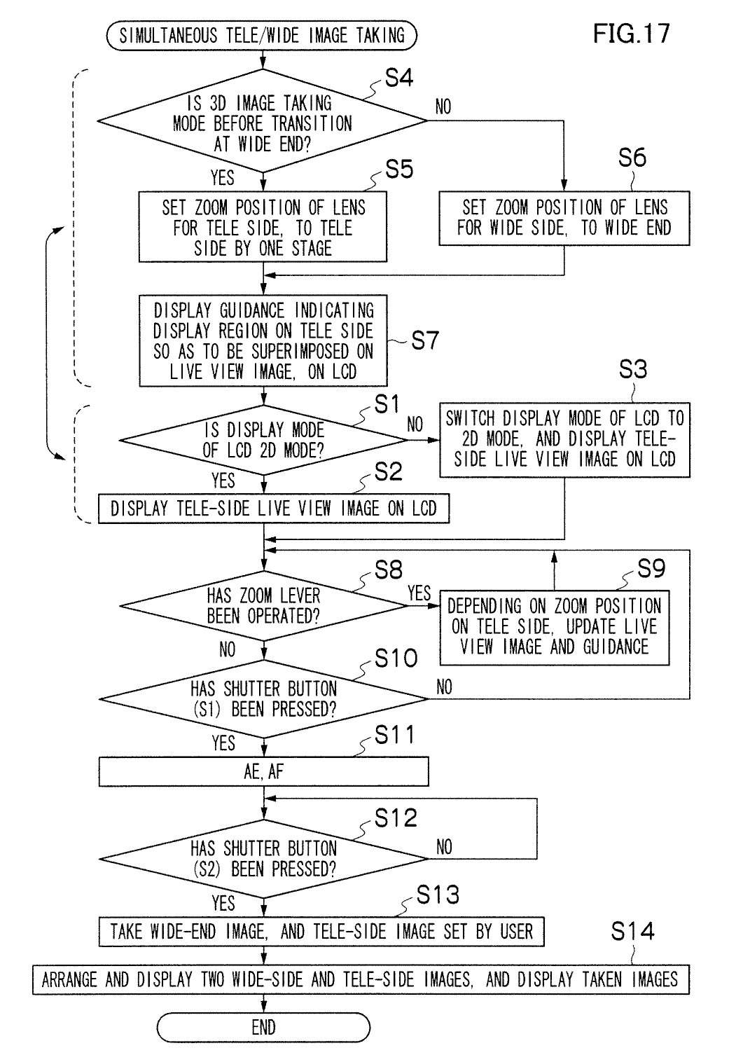

FIG. 17 is a flowchart showing the flow of the recording process for the images taken in the simultaneous tele/wide image taking mode. When the simultaneous tele/wide image taking mode is set, the image taking for the live view image is started by the left imaging system 13.

The CPU 110 determines whether or not the zoom positions of the right imaging system 12 and the left imaging system 13 are at the wide end (step S4). If the zoom positions of the right imaging system 12 and the left imaging system 13 are at the wide end (YES in step S4), the CPU 110 moves the zoom position of the left imaging system 13 which takes the tele-side image, to the tele side by one stage via the zoom lens driving unit 145 (step S5). If the zoom positions of the right imaging system 12 and the left imaging system 13 are not at the wide end (NO in step S4), the CPU 110 moves the zoom position of the right imaging system 12 which takes the wide-image, to the wide end via the zoom lens driving unit 144 (step S6).

The CPU 110 generates the guidance 30 (see FIG. 4) based on the positions of the zoom lens 12c and the zoom lens 13c after steps S5 and S6 have been performed, outputs the guidance 30 via the video encoder 134 to the monitor 16, and displays the guidance 30 so as to be superimposed on the live view image (step S7).

The CPU 110 determines whether or not the monitor 16 is in the 2D mode (step S1). If the monitor 16 is in the 2D mode (YES in step S1), the CPU 110 outputs the image data for the live view image which has been taken by the left imaging system 13, via the video encoder 134 to the monitor 16 (step S2). If the monitor 16 is not in the 2D mode (NO in step S1), the CPU 110 switches the monitor 16 from the 3D mode to the 2D mode via the video encoder 134, and outputs the image data for the live view image which has been taken by the left imaging system 13, via the video encoder 134 to the monitor 16 (step S3).

The CPU 110 determines whether or not the zoom button 21 has been operated by the user (step S8). If the zoom button 21 has been operated (YES in step S8), in response to the operation of the zoom button 21, the CPU 110 moves the zoom position of the zoom lens 13c of the left imaging system 13, via the zoom lens driving unit 145, and outputs the image data for the live view image which has been taken by the left imaging system 13, via the video encoder 134 to the monitor 16.

If the zoom button 21 has not been operated (NO in step S8), the CPU 110 determines whether or not the release switch 20 has been half pressed, that is, whether or not the S1ON signal has been inputted to the CPU 110 (step S10). If the release switch 20 has not been half pressed (NO in step S10), step S8 is performed again. If the release switch 20 has been half pressed (YES in step S10), the CPU 110 performs the AE light metering and the AF control for each of the right imaging system 12 and the left imaging system 13 (step S11). If the focused state is set once, the CPU 110 stops the lens driving of the focus lenses 12b and 13b and performs the focus lock. Then, as shown in FIG. 6, the CPU 110 displays the image captured in the focused state by the imaging element 123, on the monitor 16.

The CPU 110 determines whether or not the release switch 20 has been fully pressed, that is, whether or not the S2ON signal has been inputted to the CPU 110 (step S12). If the release switch 20 has not been fully pressed (NO in step S12), step S12 is performed again. If the release switch 20 has been fully pressed (YES in step S12), the CPU 110 obtains the signal charges accumulated in each photodiode of the imaging elements 122 and 123 to generate the image data (step S13). Since the process in step S13 is the same as the normal 2D image taking mode, the description thereof is omitted. In the present embodiment, only the image data of the tele-side image and the wide-side image needs to be obtained when the S2ON signal is inputted once, and the tele-side image and the wide-side image may be simultaneously exposed and processed, or may be sequentially exposed and processed.

The CPU 110 generates the image in which the wide-side image 31 and the tele-side image 32 which have been taken in step S13 are arranged in the same size, and displays the image as the so-called post view on the monitor 16 (step S14). Thereby, the wide-side image and the tele-side image which have been taken can be confirmed after being taken and before being recorded in the recording medium.

### Third Embodiment

In the first embodiment of the present invention, at the time of the transition from the simultaneous tele/wide image taking mode to the 3D image taking mode, the zoom positions of the right imaging system 12 and the left imaging system 13 are decided, and then the monitor 16 is set to the 3D mode. However, the order thereof is not limited thereto.

A third embodiment of the present invention is a mode in which, at the time of the transition from the simultaneous tele/wide image taking mode to the 3D image taking mode, the monitor 16 is set to the 3D mode, and then the zoom positions of the right imaging system 12 and the left imaging system 13 are decided. A compound-eye digital camera 3 of the third embodiment is different from the compound-eye digital camera 1 of the first embodiment, only in a process of the transition from the simultaneous tele/wide image taking mode to the 3D image taking mode, and thus, only the process of the transition from the simultaneous tele/wide image taking mode to the 3D image taking mode will be described, and descriptions of other portions are omitted. Moreover, the same portions as those of the first embodiment are assigned with the same reference numerals, and descriptions thereof are omitted.

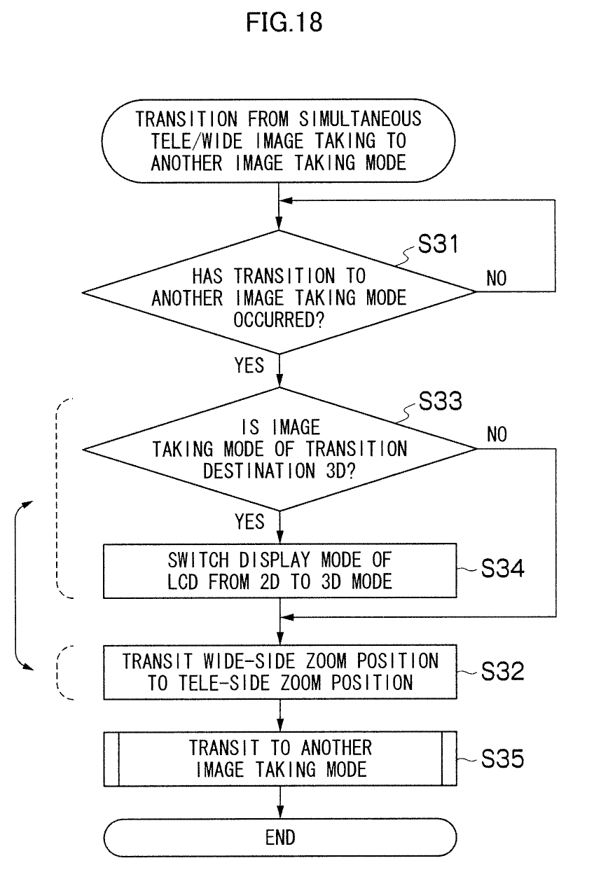

FIG. 18 is a flowchart showing the flow of the process when the mode is switched from the simultaneous tele/wide image taking mode to another image taking mode.

The CPU 110 determines whether or not the setting has been changed to another image taking mode (the normal 2D image taking mode, the 3D image taking mode or the like) (whether or not the transition to another image taking mode has occurred) via the operation of the MENU/OK button 25 or the like (step S31). If the transition to another image taking mode has not occurred (NO in step S31), step S31 is performed again.

If the transition to another image taking mode has occurred (YES in step S31), the CPU 110 determines whether or not the image taking mode of the transition destination is the 3D image taking mode (step S33). If the image taking mode of the transition destination is the 3D image taking mode (YES in step S33), the CPU 110 switches the monitor 16 into the 3D mode (step S34). The CPU 110 moves the zoom position of the right imaging system 12 which takes the wide-side image, to the zoom position of the left imaging system 13 which takes the tele-side image, via the zoom lens driving unit 144 (step S32), and starts the process in another image taking mode (step S35).

If the image taking mode of the transition destination is not the 3D image taking mode (NO in step S34), the CPU 110 holds the setting of the monitor 16 in the 2D mode, moves the zoom position of the right imaging system 12 which takes the wide-side image, to the zoom position of the left imaging system 13 which takes the tele-side image, via the zoom lens driving unit 144 (step S32), and starts the process in another image taking mode (step S35).

It should be noted that application of the present invention is not limited to the compound-eye digital camera having two imaging systems, and the present invention may be applied to a compound-eye digital camera having three or more imaging systems. In the case of the compound-eye digital camera having three or more imaging systems, it is not necessary to use all the imaging systems to perform the image taking, and at least two imaging systems may be used. Moreover, the present invention can be applied not only to the digital camera, but also to various imaging devices such as a video camera, a cellular phone and the like. Moreover, the present invention can also be provided as a program applied to the compound-eye digital camera and the like.

What is claimed is:

1. A compound-eye imaging apparatus which comprises a plurality of image pickup devices, each of which includes an image taking optical system including a zoom lens and includes an imaging element on which a subject image is formed by the image taking optical system, the compound-eye imaging apparatus being capable of taking subject images viewed from a plurality of viewpoints, as a stereoscopic image, the compound-eye imaging apparatus comprising:
an image taking mode setting device which sets a multi-image taking mode in which a plane image is taken in a different image taking range for each image pickup device of the plurality of image pickup devices;
a lens moving device which, if the multi-image taking mode is set, moves the zoom lens in an optical axis direction so that zoom positions of the plurality of image pickup devices are set to be different for each image pickup device;
a control device which, if the zoom lens has been moved by the lens moving device, takes a plurality of the plane images in the different image taking ranges via the plurality of image pickup devices;
a display device which can display one of the plane image and the stereoscopic image; and
a display control device which, if the multi-image taking mode has been set, displays an image in a narrowest image taking range, in the plurality of plane images, on a full screen of the display device, and also displays guidance which includes frames indicating the image taking ranges of the plurality of plane images, and which indicates a relationship among the image taking ranges of the plurality of plane images, on the display device.

2. The compound-eye imaging apparatus according to claim 1, wherein
the display control device displays a figure in which a plurality of the frames indicating the image taking ranges of the plurality of plane images are superimposed so that centers of the frames coincide with each other, as the guidance.

3. The compound-eye imaging apparatus according to claim 2, wherein
the display control device displays an image in a widest image taking range, in the plurality of plane images, so as to be superimposed within a frame indicating the image taking range of the image in the widest image taking range, in the plurality of plane images.

4. The compound-eye imaging apparatus according to claim 2, wherein
the display control device displays a frame indicating a limit of the image taking ranges of the plurality of plane images, so as to be superimposed on the figure in which the plurality of frames indicating the image taking ranges of the plurality of plane images are superimposed so that the centers of the frames coincide with each other.

5. The compound-eye imaging apparatus according to claim 1, wherein
the control device takes a plurality of still images as the plurality of plane images by one shutter release operation.

6. The compound-eye imaging apparatus according to claim 1, further comprising:
a switching device which inputs switching of the image to be displayed on the full screen of the display device,
wherein the control device continuously obtains an image signal indicating a subject from each imaging element, and thereby takes a plurality of moving images as the plurality of plane images, and
if the switching of the image is inputted by the switching device, the display control device displays an image other than the image in the narrowest image taking range, in the plurality of plane images, on the full screen of the display device, instead of the image in the narrowest image taking range.

7. A compound-eye imaging apparatus which comprises a plurality of image pickup devices, each of which includes an image taking optical system including a zoom lens and includes an imaging element on which a subject image is formed by the image taking optical system, the compound-eye imaging apparatus being capable of taking subject images viewed from a plurality of viewpoints, as a stereoscopic image, the compound-eye imaging apparatus comprising:
an image taking mode setting device which sets a multi-image taking mode in which a plane image is taken in a different image taking range for each image pickup device of the plurality of image pickup devices;
a lens moving device which, if the multi-image taking mode is set, moves the zoom lens in an optical axis direction so that zoom positions of the plurality of image pickup devices are set to be different for each image pickup device;
a control device which, if the zoom lens has been moved by the lens moving device, takes a plurality of the plane images in the different image taking ranges via the plurality of image pickup devices;
a display device which can display one of the plane image and the stereoscopic image; and
a display control device which, if the multi-image taking mode has been set, arranges and displays the plurality of plane images in the different image taking ranges, on the display device.

8. The compound-eye imaging apparatus according to claim 7, wherein
the display control device displays a frame indicating the image taking range of an image in a narrowest image taking range, in the plurality of plane images, so as to be superimposed on an image in a widest image taking range, in the plurality of plane images.

9. The compound-eye imaging apparatus according to claim 7, wherein
the control device takes a plurality of still images as the plurality of plane images by one shutter release operation, or continuously obtains an image signal indicating a subject from each imaging element and thereby takes a plurality of moving images as the plurality of plane images.

10. The compound-eye imaging apparatus according to claim 1, further comprising:
an input device which inputs an instruction to change the image taking range,
wherein the control device controls the lens moving device to change the zoom position of the image pickup device which takes the image in the narrowest image taking range, in the plurality of plane images, based on the input from the input device, and
the display control device changes the image displayed on the display device, and also changes a size of the frame indicating the image taking range, in response to the change of the zoom position.

11. The compound-eye imaging apparatus according to claim 8, further comprising:
an input device which inputs an instruction to change the image taking range,
wherein the control device controls the lens moving device to change the zoom position of the image pickup device which takes the image in the narrowest image taking range, in the plurality of plane images, based on the input from the input device, and
the display control device changes the image displayed on the display device, and also changes a size of the frame indicating the image taking range, in response to the change of the zoom position.

12. The compound-eye imaging apparatus according to claim 1, wherein
the lens moving device sets the zoom position of the image pickup device which takes the image in the widest image taking range, in the plurality of plane images, at a wide end.

13. The compound-eye imaging apparatus according to claim 7, wherein
the lens moving device sets the zoom position of the image pickup device which takes the image in the widest image taking range, in the plurality of plane images, at a wide end.

14. The compound-eye imaging apparatus according to claim 1, wherein
the display device can perform switching between a mode for displaying the stereoscopic image and a mode for displaying the plane image, and
a switching device which, if the multi-image taking mode is set, switches a mode from the mode for displaying the stereoscopic image to the mode for displaying the plane image, is further included.

15. The compound-eye imaging apparatus according to claim 7, wherein
the display device can perform switching between a mode for displaying the stereoscopic image and a mode for displaying the plane image, and
a switching device which, if the multi-image taking mode is set, switches a mode from the mode for displaying the stereoscopic image to the mode for displaying the plane image, is further included.

16. The compound-eye imaging apparatus according to claim 1, further comprising:
a selection device which selects whether to automatically store all the plurality of plane images taken by the plurality of image pickup devices by one shutter release operation, or to store only a predetermined plane image; and
a storage device which, if the automatic storage of all the plurality of plane images has been selected by the selection device, stores the plurality of plane images, and if the storage of only the predetermined plane image has been selected by the selection device, stores the predetermined plane image.

17. The compound-eye imaging apparatus according to claim 7, further comprising:
a selection device which selects whether to automatically store all the plurality of plane images taken by the plurality of image pickup devices by one shutter release operation, or to store only a predetermined plane image; and
a storage device which, if the automatic storage of all the plurality of plane images has been selected by the selection device, stores the plurality of plane images, and if the storage of only the predetermined plane image has been selected by the selection device, stores the predetermined plane image.

18. The compound-eye imaging apparatus according to claim 1, further comprising:
a flash light device which emits flash light to illuminate the subject; and
a flash light control device which, if the multi-image taking mode is set, controls the flash light device to stop the light emission of the flash light device.

19. The compound-eye imaging apparatus according to claim 7, further comprising:
a flash light device which emits flash light to illuminate the subject; and
a flash light control device which, if the multi-image taking mode is set, controls the flash light device to stop the light emission of the flash light device.
